(19) United States
(12) Patent Application Publication
(10) Pub. No.: US 2026/0331660 A1
(43) Pub. Date: Oct. 22, 2026

(54) GASKET FOR SECONDARY BATTERY AND SECONDARY BATTERY INCLUDING GASKET

(71) Applicant: SAMSUNG SDI CO., LTD., Yongin-si (KR)

(72) Inventors: Sanghyup MOON, Yongin-si (KR); Kyungup MIN, Yongin-si (KR); Keunwoo PARK, Yongin-si (KR)

(21) Appl. No.: 19/408,691

(22) Filed: Dec. 4, 2025

(30) Foreign Application Priority Data
Apr. 22, 2025 (KR) 10-2025-0052669

(51) Int. Cl. H01M 50/184; H01M 50/107; H01M 50/152; H01M 50/167; H01M 50/186; H01M 50/586

(52) U.S. Cl. CPC H01M 50/184; H01M 50/107; H01M 50/152; H01M 50/167; H01M 50/186; H01M 50/586

(57) ABSTRACT

A secondary battery according to some embodiments of the present disclosure may include an electrode assembly; a case having a cylindrical shape that may include a bottom, a side wall connected to the bottom, and an opening opposite to the bottom, the case being configured to accommodate the electrode assembly; a cap assembly placed over the opening of the case; and a gasket disposed between the cap assembly and the case. The gasket may include a body and an extension that extends in an inward direction of the case from one end of the body toward another end of the body. A first thickness d1 of the one end of the body may be smaller than a second thickness d2 of the another end of the body.

### CROSS-REFERENCE TO RELATED APPLICATION

This application claims priority under 35 U.S.C. § 119 to Korean Patent Application No. 10-2025-0052669, filed in the Korean Intellectual Property Office on Apr. 22, 2025, the entire contents of which are hereby incorporated by reference.

### BACKGROUND

### Field

The present disclosure relates to a gasket for a secondary battery and a secondary battery including the gasket.

### Description of Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

A cylindrical-shaped secondary battery has a high energy density and excellent stability for use in various electronic devices. A cylindrical-shaped secondary battery may include a gasket disposed between a case and a cap assembly for sealing the case. When the gasket fails to properly seal the case, an electrolyte injected into the inside of the secondary battery may be leaked to the outside, and a whitening phenomenon may occur where the case is eroded by the leaked electrolyte. As a result, the performance and reliability of the secondary battery may be degraded.

The above information disclosed in this Background section is for enhancement of understanding of the background of the present disclosure, and therefore, it may contain information that does not constitute related (or prior) art.

### SUMMARY

The present disclosure aims to provide a gasket for a secondary battery, and a secondary battery including the gasket, for solving the above-described problems.

These and other aspects and features of the present disclosure will be described in or will be apparent from the following description of embodiments of the present disclosure.

A secondary battery according to some embodiments of the present disclosure may include an electrode assembly; a case having a cylindrical shape that may include a bottom, a side wall connected to the bottom, and an opening opposite to the bottom, the case being configured to accommodate the electrode assembly; a cap assembly placed over the opening of the case; and a gasket disposed between the cap assembly and the case. The gasket may include a body and an extension that extends in an inward direction of the case from one end of the body toward another end of the body. A first thickness d1 of the one end of the body may be smaller than a second thickness d2 of the another end of the body.

In some embodiments, an angle between an outer surface of the body and an inner surface of the body may be in a range from about 1 degree to about 3 degrees.

In some embodiments, a thickness of the body increases from the one end of the body toward the another end of the body.

In some embodiments, a diameter r1 of an inner surface of the body decreases from the one end of the body toward the another end of the body.

In some embodiments, the diameter r1 of the inner surface of the body may be smaller than or the same as a diameter of an outer surface of the cap assembly.

In some embodiments, a diameter r2 of an outer surface of the body increases from the one end of the body toward the another end of the body.

In some embodiments, the diameter r2 of the outer surface of the body may be smaller than or the same as a diameter of an inner surface of the side wall.

In some embodiments, a diameter r1 of an inner surface of the body decreases from the one end of the body toward the another end of the body. A diameter r2 of an outer surface of the body increases from the one end of the body toward the another end of the body.

In some embodiments, the second thickness d2 may be from about 105% to about 115% of the first thickness d1.

In some embodiments, the second thickness d2 may be greater than the first thickness d1 by a length of from about 0.05 mm to about 0.15 mm.

In some embodiments, the body may include a horizontal part configured to contact an upper surface of the cap assembly, a vertical part configured to contact a side surface of the cap assembly, and a bending part configured to connect the horizontal part of the body to the vertical part of the body. A third thickness d3 of the body at the bending part of the body may be greater than the first thickness d1.

In some embodiments, the third thickness d3 may be from about 101% to about 110% of the first thickness d1.

In some embodiments, the third thickness d3 may be greater than the first thickness d1 by a length of from about 0.01 mm to about 0.05 mm.

In some embodiments, the side wall may include a crimping part bent in the inward direction of the case to press and fix the cap assembly and the gasket. The body may be bent at a specific position F and surrounds the cap assembly.

In some embodiments, a fourth thickness d4 of the body at the specific position F of the body may be from about 101% to about 110% of the first thickness d1.

A gasket for a secondary battery according to some embodiments of the present disclosure may include a body having a cylindrical shape and an extension that extends in an inward direction of the body from one end of the body to another end of the body. A first thickness d1 of the one end of the body may be smaller than a second thickness d2 of the another end of the body.

In some embodiments, an angle between an outer surface of the body and an inner surface of the body may be in a range from about 1 degree to about 3 degrees.

In some embodiments, a thickness of the body increases from the one end of the body toward the another end of the body. A diameter r1 of an inner surface of the body decreases from the one end of the body toward the another end of the body.

In some embodiments, a thickness of the body increases from the one end of the body toward the another end of the body. A diameter r2 of an outer surface of the body increases from the one end of the body toward the another end of the body.

In some embodiments, the second thickness d2 may be from about 105% to about 115% of the first thickness d1.

According to some embodiments of the present disclosure, a gasket may be completely attached to a crimping part, which may suppress the electrolyte inflow through the gap between the gasket and the crimping part and may suppress an occurrence of hydrogen fluoride gas leakage. Accordingly, a performance degradation due to damage to the case and the cap assembly and a stability degradation of the secondary battery may be resolved.

According to some embodiments of the present disclosure, as the thickness of the body of a gasket increases along the direction of the other end of the body, the body may be completely attached to the crimping part without a gap during the forming of the crimping part.

According to some embodiments of the present disclosure, the inner surface and/or outer surface of the body may be inclined inward to the inside of the gasket. Accordingly, the outer surface of the body may not interfere with the side wall, so that the gasket may be easily inserted into the case.

According to some embodiments of the present disclosure, as the body increases in thickness at a consistent ratio, precision and production efficiency in a manufacturing process of the gasket may be improved. By adjusting the angle between the inner side and the outer side of the body during the manufacturing process of the gasket, the thickness at an interface between the body and the crimping part may be adjustable, thereby improving the efficiency of the manufacturing process.

According to some embodiments of the present disclosure, with the inner side and/or the outer side of the body being inclined outward to the outer side of the gasket, the inner side of the body may not interfere with the cap assembly so that the cap assembly may be easily inserted into the inside of the gasket.

According to some embodiments of the present disclosure, by forming the inner side and/or the outer side of the body inclined outward toward the outer side of the gasket, demolding can be facilitated during an injection molding process of the gasket, which can improve the efficiency of the manufacturing process.

However, aspects and features of the present disclosure are not limited to those described above, and other aspects and features not mentioned will be clearly understood by a person skilled in the art from the detailed description and/or the drawings of the present disclosure.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a cross-sectional view illustrating a secondary battery according to some embodiments of the present disclosure.

FIG. 2 is a cross-sectional view illustrating a secondary battery according to some embodiments of the present disclosure.

FIG. 3 is a view illustrating a gasket for a secondary battery according to some embodiments of the present disclosure.

FIGS. 4 to 6 are cross-sectional views illustrating a gasket for a secondary battery according to some embodiments of the present disclosure.

FIG. 7 is a view illustrating a gasket for a secondary battery according to some embodiments of the present disclosure.

FIG. 8 is a cross-sectional view illustrating a gasket for a secondary battery according to some embodiments of the present disclosure.

FIG. 9 is a view illustrating a gasket for a secondary battery according to some embodiments of the present disclosure.

FIG. 10 is a cross-sectional view illustrating a gasket for a secondary battery according to some embodiments of the present disclosure.

FIG. 11 is an illustration comparing two gaskets for a secondary battery according some embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value greater than or equal to 1.0 and a maximum value less than or equal to 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components.”

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

According to some embodiments of the present disclosure, sizes of layers and areas that are illustrated in the drawings may be exaggerated for clarity of explanation. The sizes in the drawings are only for ease of explanation, but the present disclosure is not limited thereto. Further, like reference numerals in the drawings denote like elements throughout the specification.

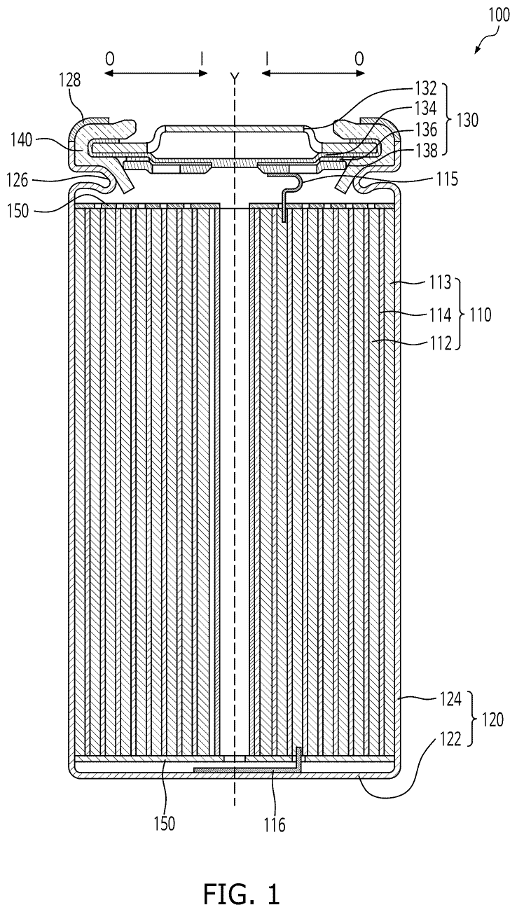

FIG. 1 is a cross-sectional view illustrating a secondary battery 100 according to some embodiments of the present disclosure. The secondary battery 100 may include an electrode assembly 110, a case 120 configured to accommodate the electrode assembly 110, a cap assembly 130 configured to seal the case 120, and a gasket 140 configured to insulate the case 120 and the cap assembly 130, and an insulating plate 150 disposed between the electrode assembly 110 and the cap assembly 130.

The electrode assembly 110 may include a first electrode 112, a second electrode 113, and a separator 114 disposed between the first electrode 112 and the second electrode 113. The first electrode 112, the second electrode 113, and the separator 114 may be wound in a jelly-roll shape with respect to a winding-axis Y.

The first electrode 112 may include a first substrate and a first active material layer disposed on the first substrate. A first lead tab 115 may extend outward from a first non-coated part of the first substrate where the first active material layer is not arranged. The first lead tab 115 may be electrically connected to the cap assembly 130. The first non-coated part may be connected to a current collector (not shown). The current collector may be connected to the cap assembly 130 directly or through a separate lead tab.

The first electrode 112 may function as a positive electrode. The first substrate may be formed of, for example, aluminum foil, and the first active material layer may include, for example, a transition metal oxide.

The second electrode 113 may include a second substrate and a second active material layer disposed on the second substrate. A second lead tab 116 may extend outward from a second non-coated part of the second substrate where the second active material layer is not arranged. The second lead tab 116 may be electrically connected to the case 120. The second lead tab 116 may be coupled to a bottom 122 of the case 120 by welding, but the present disclosure is not limited thereto. The second non-coated part may be connected to a current collector (not shown). The current collector may be connected to the case 120 directly or through a separate lead tab.

The first lead tab 115 and the second lead tab 116 may extend in opposite directions. Alternatively, the first lead tab 115 and the second lead tab 116 may extend in a same direction.

The second electrode 113 may function as a negative electrode. The second electrode may be formed of, for example, copper foil or nickel foil, and the second active material layer may include, for example, graphite, silicon, etc. However, the present disclosure is not limited thereto, but the first electrode 112 may function as a negative electrode, and the second electrode 113 may function as a positive electrode.

The separator 114 may allow the movement of ions and may prevent a short circuit between the first electrode 112 and the second electrode 113. The separator 114 may be formed of, for example, a polyethylene film, a polypropylene film, a polyethylene-polypropylene film, etc.

The case 120 may accommodate the electrode assembly 110 and an electrolyte. The case 120 may include the bottom 122, a side wall 124 connected to the bottom 122, and an opening that faces the bottom 122. The electrode assembly 110 may be inserted into the case 120 through the opening of the case 120. The case 120 may have a cylindrical shape and may form an exterior of the secondary battery along with the cap assembly 130. The case 120 may include steel, a steel alloy, aluminum, an aluminum alloy or an equivalent thereof, but the case 120 is not limited thereto.

The side wall 124 of the case 120 may include a beading part 126 and a crimping part 128. The beading part 126 may be formed by the side wall 124 being recessed in an inward direction I, which is an inward vector of the radial direction O-I of the case 120, and the beading part 126 may support the cap assembly 130 and the gasket 140. The beading part 126 may suppress the movement of the electrode assembly 110 inside the case 120, and the beading part 126 may facilitate mounting of the gasket 140 and the cap assembly 130. The crimping part 128 may be formed by bending the end portion of the side wall 124 in the inward direction I. The crimping part 128 may firmly fix the cap assembly 130 by pressing an edge of the cap assembly 130 through the gasket 140.

The cap assembly 130 may include an upper cap 132 having a plurality of through-holes, a vent plate 134 disposed under the upper cap 132, an insulator 136 disposed under the vent plate 134, and a lower cap 138 disposed under the vent plate 134 and the insulator 136 and electrically connected to the first lead tab 115. The center of the vent plate 134 may contact the lower cap 138, and the edge supported by the insulator 136 may be spaced apart from the lower cap 138. However, depending on the design, the components of the cap assembly 130 may vary. The cap assembly 130 may have a structure without the upper cap 132. In the cap assembly 130, the lower cap 138 may be omitted, and the vent plate 134 may be directly connected to a lead tab or a current collector.

The vent plate 134 may be provided with a notch that may rupture when the internal pressure exceeds a predetermined level and may release gas. When gas forms inside the case 120 and an abnormal internal pressure thus forms, the gas may pass through the through-hole of the lower cap 138 and may deform the shape of the vent plate 134 so that the vent plate 134 and the lower cap 138 may be electrically separated. Therefore, the vent plate 134 may rupture, and the gas may be discharged to the outside through the through hole of the upper cap 132.

According to some embodiments, the gasket 140 may insulate the case 120 and the cap assembly 130. In addition, the gasket 140 may be compressed between the beading part 126 and the crimping part 128 formed at the side wall 124, thereby sealing the case 120.

The insulating plate 150 may be arranged to contact the electrode assembly 110 under the beading part 126. The insulating plate 150 may include a tab opening for withdrawing the first lead tab 115. The cap assembly 130 electrically connected to the first electrode 112 through the first lead tab 115 may be disposed to face the electrode assembly 110 with the insulating plate 150 interposed between the cap assembly 130 and the electrode assembly 110 and may maintain an insulating state with the electrode assembly 110 because of the insulating plate 150.

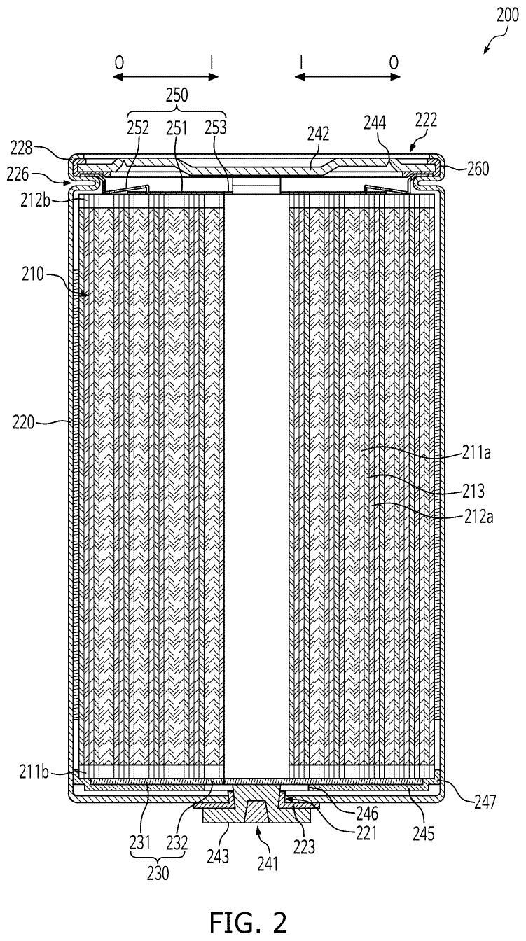

FIG. 2 is a cross-sectional view illustrating a secondary battery 200 according to some embodiments of the present disclosure. The secondary battery 200 may include an electrode assembly 210, a case 220 configured to accommodate the electrode assembly 210, a first current collector 230 connected to the electrode assembly 210, a second current collector 250, an electrode terminal 241, a cap assembly 242, and a gasket 260. FIG. 2 illustrates that the cap assembly 242 is arranged in the top of the secondary battery 200, and the electrode terminal 241 is arranged under the secondary battery 200, but the present disclosure is not limited thereto. Based on an environment or specific requirements in which the secondary battery 200 is used, the cap assembly 242 and the electrode terminal 241 may be disposed on the top or under the secondary battery 200.

The electrode assembly 210 may be formed into a cylindrical jelly roll shape with a hollow core by winding first electrodes, a separator 213, and second electrodes with parts. The first electrodes, and the second electrode 212a and 212b may include coating parts 211a and 212a, where an active material is coated on both sides of a thin metal foil plate, and non-coated parts 211b and 212b, where the substrate is exposed without the active material.

The first electrodes may be positive or negative electrodes in the secondary battery 200. The second electrodes may be the electrodes opposite to the first electrodes. When the first electrodes are positive electrodes, the second electrodes may be negative electrodes. Conversely, when the first electrodes are negative electrodes, the second electrodes may be positive electrodes.

The first electrodes may form a positive electrode by coating a positive active material on an aluminum (Al) substrate, and the second electrodes may form a negative electrode by coating a negative active material on a copper (Cu) substrate. The non-coated part 211b of the first electrode and the non-coated portion 212b of the second electrode may be respectively provided at both ends of the electrode assembly 210 in a winding axis direction, but an electrode terminal 241 and a case 220 having different polarities in the same direction may be provided. A cap assembly 242 may be positioned on an opposite side of the electrode terminal 241.

The case 220 may be formed to accommodate the electrode assembly 210, and the electrode terminal 241 and the cap assembly 242 may be provided at both ends in the axis direction of the case 220 to face each other.

The electrode terminal 241 may be connected to the first electrodes with parts with the first current collector 230 through a rivet part 243, and the case 220 may be connected to the second electrodes with the second current collector 250. The cap assembly 242 may be electrically spaced from the second current collector 250 and the case 220 and may not have polarity.

The electrode terminal 241 connected to the first electrodes of the electrode assembly 210 inserted into the case 220 from the outside may be provided on one side of the case 220. The case 220 may have a through hole 221 partially open on one side.

The electrode terminal 241 may have a rivet structure at the through hole 221 of the case 220. The electrode terminal 241 may be connected to the rivet part 243. One end of the rivet part 243 may be connected to the first current collector 230 by welding and may be arranged to penetrate the through hole 221. The electrode terminal 241 may be connected to the rivet part 243 and may be arranged on the outer side of the case 220. The electrode terminal 241 may protrude from an outer surface of the case 220 surrounding the through hole 221 to be used as a positive electrode terminal. The first current collector 230 may be a positive electrode current collector.

The first current collector 230 may be electrically connected to a non-coated part 211b of the first electrode through the rivet part 243, and electrically and mechanically connected to the electrode terminal 241. The first current collector 230 may contact most areas of the non-coated part 211b of the first electrode to reduce the resistance while electrically connecting to the electrode terminal 241. The rivet part 243 included in the electrode terminal 241 may form a sealing structure for an electrolyte with an insulator 223 disposed at the through hole 221 while being electrically insulated from the case 220.

The insulator 223 may be made of a polymer including ethylene propylene rubber (EPDM), polypropylene (PP), polyimide (PI), polyethylene terephthalate (PET), polycarbonate (PC), or a combination thereof.

The insulator 223 may be made of a ceramic material including epoxy resin, alumina (Al2O3), zirconia (ZrO2), aramid fiber, nomex, or a combination thereof. However, the material of the insulator 223 is not limited to the materials described above and may include various materials with excellent plasticity and insulation properties depending on the selection.

According to some embodiments, the first current collector 230 may include a metal plate 231 including at least one bridge 232. The first collector plate of the first current collector 230 may be made of a conductive metal such as nickel, aluminum, copper, silver, zinc, tin, stainless steel (e.g., SUS), nickel-plated steel, or a combination (alloy) thereof. In addition, the metal plate 231 and the bridge 232 constituting the first current collector 230 may be made of a same material and may form an integrated body, but the present disclosure is not limited thereto.

When a current exceeding a preset value flows through the first current collector 230, the bridge 232 of the first current collector 230 may rupture. The bridge 232 may operate as part of a circuit through which a current flows, but, when an excessive current flows, the bridge 232 may melt down due to the generated heat and function as a fuse that blocks the circuit.

An insulating tape 245 may be attached to one side of the first current collector 230. The insulating tape 245 may be disposed between the first current collector 230 and the case 220, or between a non-coated part 211b of the first electrode and the case 220 and may electrically insulate each component. According to some embodiments of the present disclosure, the center of the insulating tape 245 may include a hollow 246 corresponding to the shape of the rivet part 243 so that the rivet part 243 may contact the first current collector 230. The insulating tape 245 may include a side wall 247 to surround part of the electrode assembly 210.

The case 220 may accommodate the electrode assembly 210. An opening 222 that is completely open and for insertion of the electrode assembly 210 may be formed on one side of the case 220 including the through hole 221, and on the other side of the case 220. The cap assembly 242 may seal the opening 222 of the case 220 that accommodates the electrode assembly 210.

The case 220 may include a beading part 226 and a crimping part 228. The beading part 226 may be formed by the case 220 recessed in an inward direction I of the case 220 and may support the cap assembly 242 and a gasket 260. The beading part 226 may suppress the electrode assembly 210 from moving inside the case 220 and may allow the gasket 260 and the cap assembly 242 to be easily mounted. The crimping part 228 may be formed by an end portion of the case 220 recessed in the inward direction I. The crimping part 228 may press the edge of the cap assembly 242 through the gasket 260 to firmly fix the cap assembly 242.

The second current collector 250 may be electrically connected to the non-coated part 212b of the second electrode and may be electrically connected to the case 220. The second current collector 250 may be connected to the case 220 by contacting most areas of the non-coated part 212b of the second electrode to reduce resistance in the second electrode.

The second current collector 250 may include a flat part 251 welded to the non-coated part 212b of the second electrode and a wing part 252 formed adjacent to the flat part 251 and welded to the beading part 226. The second current collector 250 may be formed by cutting and bending a plate and may include a plurality of flat parts 251 and a plurality of wing parts 252 alternately arranged along a circumferential direction of the secondary battery. The wing part 252 may be formed by repeated bending of the electrode assembly 210 in an axial direction (upward) of the electrode assembly 210 and a radial direction (outward) of the electrode assembly 210.

When the non-coated part 212b of the second electrode is welded to the flat part 251 of the second current collector 250, the flat part 251 may form a welding line in the diameter direction of the second current collector 250. Therefore, the flat part 251 may be uniformly connected along a circumferential direction of the secondary battery in the area of the non-coated part 212b of the second electrode, and the wing part 252 may be uniformly connected along the circumferential direction of the secondary battery in the area of the beading part 226. For the non-coated part 212b of the second electrode, a current may flow uniformly along the circumferential direction of the secondary battery in all areas of the beading part 226. The second current collector 250 may include a hole 253 at a center of the second current collector 250 to absorb deformation due to the welding between the flat part 251 and the non-coated part 212b of the second electrode and to absorb vibration and shock transmitted between the wing part 252 and the flat part 251. The hole 253 may have a size within a range that absorbs vibration and shock without increasing a current resistance between the wing part 252 and the flat part 251.

In the non-coated part 212b of the second electrode, a current may flow uniformly along the circumferential direction of the secondary battery in all areas of the beading part 226 of the case 220. The second current collector 250 may include a hole 253 at the center to absorb and mitigate deformation due to the welding between the flat part 251 and the non-coated part 212b of the second electrode, and vibration and shock transmitted between the wing part 252 and the flat part 251. The hole 253 may have a size within a range that absorbs vibration and shock without increasing the current resistance between the wing part 252 and the flat part 251.

According to some embodiments, a cap assembly may include a vent plate and a lower cap. The vent plate may be electrically separated from the second current collector 250. The case 220 may be connected to the second current collector 250 to function as a negative terminal, and the second current collector 250 may be a negative electrode current collector. The lower cap may be arranged under the vent plate and may be electrically connected to the second current collector 250. However, the components of the cap assembly 242 may vary depending on the design, and the components of the cap assembly 242 are not limited to the structure in the drawings and descriptions above. In some embodiments, the cap assembly 242 may be configured with only the vent plate, and the vent plate may be directly connected to the second current collector 250. In some embodiments, the cap assembly 242 may further include a upper cap arranged at the top of the vent plate.

The vent plate may include a notch 244. The notch 244 may be cut to discharge the inner pressure of the secondary battery 200 to the outside for when an abnormal event occurs in the secondary battery 200, thereby preventing an explosion. Specifically, the notch 244 may be easily cut when an internal pressure is subject to the concentrated stress during abnormal events. The notch 244 may be formed in the entire area along the circumferential direction of the cap assembly 242 and may include a plurality of notches spaced apart each other at a predetermined distance.

The gasket 260 may be disposed between the second current collector 250 and the cap assembly 242 and between the second current collector 250 and the case 220. The gasket 260 may form a sealing structure for an electrolyte between the second current collector 250 and the opening 222 of the case 220.

The gasket 260 may include a polymer material or ceramic such as polyvinyl chloride (PVC), polytetrafluoroethylene (PTFE or Teflon), polyethylene (PE), epoxy resin, silicone, polyvinylidene fluoride (PVDF), polypropylene (PP), polyacrylonitrile (PAN), or polyethylene oxide (PEO), but the gasket 260 is not limited thereto. The material may correspond to any one of the appropriate compounds used as an insulating material in the present technical field.

The secondary battery according to some embodiments of the present disclosure may be applied to vehicles, mobile phones, and/or various types of electronic devices, but the present disclosure is not limited thereto.

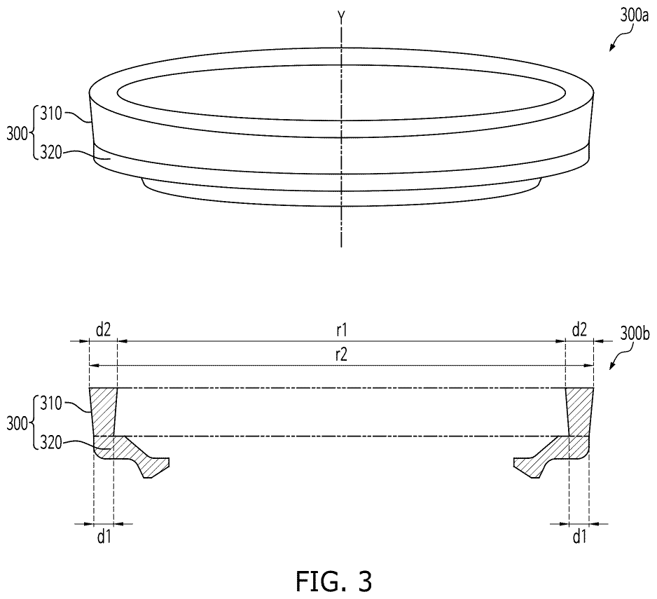

FIG. 3 is a view of a gasket 300 for a secondary battery according to some embodiments of the present disclosure. A first example 300a and a second example 300b are a perspective view and a cross-sectional view, respectively, showing the gasket 300 before being assembled into the secondary battery. The gasket 300 shown in the first example 300a and the second example 300b may be substantially the same as the gasket shown in FIG. 1 (e.g., 140 of FIG. 1) or the gasket shown in FIG. 2 (e.g., 260 of FIG. 2).

The gasket 300 may include a body 310 having a cylindrical shape and an extension 320 that extends from one end of the body 310. The gasket 300 may be disposed inside the case of the secondary battery so that the extension 320 may be mounted on the beading part (e.g., 126 of FIG. 1) of the secondary battery. At least part of the outer side of the body 310 may be arranged to contact the side wall (e.g., 124 of FIG. 1) of the case. After the assembly (e.g., 130 of FIG. 1) is inserted into the inside of the body 310, the crimping part (e.g., 128 of FIG. 1) may be formed, and the body 310 may be bent with the crimping part accordingly.

The thickness of the body 310 may vary depending on the height of the body 310. The thickness of the body 310 may indicate the distance between the outer side and the inner side of the body 310. The thickness of the body 310 at one end of the body 310 that contacts the extension 320 may be a first thickness d1, and the thickness of the body 310 at the other end of the body 310 may be a second thickness d2. The first thickness d1 may be smaller than the second thickness d2.

The thickness of the body 310 may increase from one end of the body 310 toward the other end of the body 310. The distance between the outer side and the inner side of the body 310 may increase toward the other end of the body 310. The inner side and the outer side of the body 310 may have a predetermined angle.

In some embodiments, the thickness of a specific section of the body 310 may increase from one end of the body 310 toward the other end of the body 310, and the thickness of the body 310 at locations other than the specific section may remain constant or may decrease toward the other end of the body 310. With respect to the section extending from one end of the body 310 to a predetermined height, the thickness of the body 310 may increase from the one end of the body 310 toward the other end of the body 310, and the thickness of other sections of the body 310 may remain constant.

According to some embodiments, as the thickness of the body 310 varies depending on the height of the body 310, the inner side and/or the outer side of the body 310 may be inclined with respect to a central axis Y of the gasket 300. The inner side of the body 310 may be parallel to the central axis Y of the gasket 300, and the outer side of the body 310 may have a predetermined angle with respect to the central axis Y. In some embodiments, the outer side of the body 310 may be parallel to the central axis Y of the gasket 300, and the inner side may have a predetermined angle with respect to the central axis Y. Each of the outer side and the inner side of the body 310 may have a predetermined angle with respect to the central axis Y.

A diameter of the inner side of the body 310 may be greater than a diameter of the outer side of the cap assembly (e.g., 130 of FIG. 1) arranged inside the body 310 or may be the same as the diameter of the outer side of the cap assembly (e.g., 130 of FIG. 1). When the diameter of the inner side of the body 310 varies depending on the height of the body 310, a minimum diameter r1 of the inner side of the body 310 may be greater than or may be the same as the maximum diameter of the outer side of the cap assembly. Accordingly, the inner side of the body 310 may not interfere with the cap assembly, so that the cap assembly may be easily inserted into the inside of the body 310.

The diameter of the outer side of the body 310 may be smaller than or the same as the diameter of the inner side of the side wall of the case. When the diameter of the outer side of the body 310 varies depending on the height of the body 310, a maximum diameter r2 of the outer side of the body 310 may be smaller than or the same as the minimum diameter of the inner side of the side wall. Accordingly, the outer side of the body 310 may not interfere with the side wall of the case, so that the gasket 300 may be easily inserted into the case.

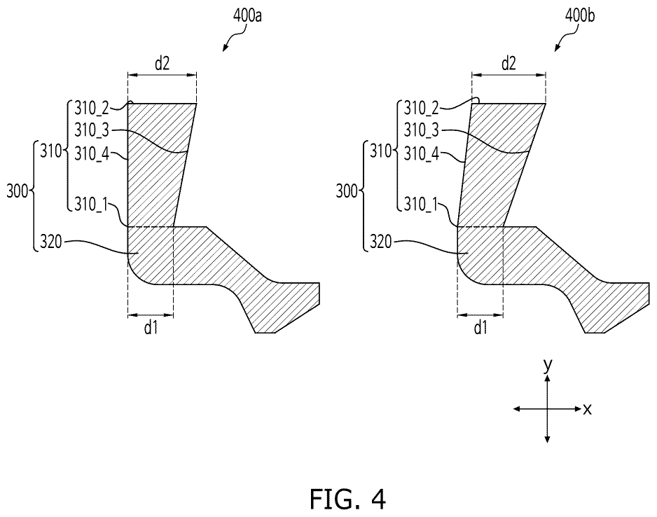

FIG. 4 is a cross-sectional view illustrating a gasket 300 for a secondary battery according to some embodiments of the present disclosure. Particularly, FIG. 4 is an enlarged cross-sectional view illustrating a gasket (e.g., 300 of FIG. 3). The gasket 300 may include a body 310 and an extension 320 that extends from one end 310_1 of the body 310.

According to some embodiments, a thickness d1 of one end 310_1 of the body 310 may be smaller than a second thickness d2 of the other end 310_2 of the body 310. The thickness of the body 310 may increase from the one end 310_1 of the body 310 toward the other end 310_2 of the body 310. The distance between an outer side 310_4 of the body 310 and an inner side 310_3 of the body 310 may increase from the one end 310_1 of the body 310 toward the other end 310_2 of the body 310.

The inner side 310_3 and/or the outer side 310_4 of the body 310 may be inclined with respect to the central axis (Y-axis) of the gasket 300. Accordingly, the thickness of the body 310 may increase toward the other end 310_2 of the body 310.

Referring to a first example 400a, the inner side 310_3 of the body 310 may be inclined toward the inside of the gasket 300 to have a predetermined angle with respect to the central axis (Y-axis) of the gasket 300, and the outer side 310_4 of the body 310 may be parallel to the central axis (Y-axis) of the gasket 300. Accordingly, the first thickness d1 may be smaller than the second thickness d2.

Referring to a second example 400b, the inner surface 310_3 of the body 310 may be inclined toward the inside of the gasket 300 to have a first angle with respect to the central axis (Y-axis) of the gasket 300, and the outer surface 310_4 of the body 310 may be inclined toward the inside of the gasket 300 to have a second angle with respect to the central axis (Y-axis) of the gasket 300. The first angle between the inner surface 310_3 of the body 310 and the central axis (Y-axis) of the gasket 300 and the second angle between the outer surface 310_4 of the body 310 and the central axis (Y-axis) of the gasket 300 may be different. In addition, the first angle may be greater than the second angle. Accordingly, the first thickness d1 may be smaller than the second thickness d2.

The angle between the inner surface 310_3 and the outer surface 310_4 of the body 310 may be from about 1 (one) degree to about 3 (three) degrees. The inner surface 310_3 of the body 310 may be formed with an inclination from about 1 (one) degree to about 3 (three) degrees toward the inside of the gasket 300 more than an inclination of the outer surface 310_4 of the body 310 toward the inside of the gasket 300.

As the thickness of the body 310 of the gasket 300 increases toward the other end 310_2 of the body 310, the body 310 may be closely attached to a crimping part during the forming of the crimping part. The inner surface 310_3 and/or the outer surface 310_4 of the body 310 may be inclined toward the inside of the gasket 300, so that the outer surface 310_4 of the body 310 may not interfere with the side wall of the case. Accordingly, the gasket 300 may be easily inserted into the case.

Additionally, as the thickness of the body 310 increases at a consistent ratio, a precision and a production efficiency during a process of manufacturing the gasket 300 may be improved. During the process of manufacturing the gasket 300, the thickness of the area where the body 310 contacts the crimping part (e.g., a partial area between one end 310_1 and the other end 310_2 of the body 310) may be adjusted only by adjusting the angle between the inner surface 310_3 and the outer surface 310_4 of the body 310, thereby improving an efficiency of manufacturing management.

When the first thickness d1 of one end 310_1 of the main body 310 is about 0.64 mm and the height of the main body 310 is about 3.0 mm, the second thickness d2 of the other end 310_2 of the body 310 may be from about 0.69 mm to about 0.74 mm. The second thickness d2 may be from about 105% to about 115% of the first thickness d1. In addition, the second thickness d2 may be from about 0.05 mm to about 0.15 mm greater than the first thickness d1. However, the ranges of the first thickness d1 and the second thickness d2 are not limited thereto but may be flexibly changed within a predetermined range depending on a design of a secondary battery and a gasket.

Table 1, below, illustrates results of an experiment that measures a size of the gap between a gasket and a crimping part with respect to the gasket in which a first thickness d1 of one end of the body is about 0.64 mm and a height of the body is about 3.0 mm. The gasket according to a comparative example may be designed so that an angle between inner surfaces and outer surfaces of the body may be 0 (zero) degree and a second thickness d2 of the other end of the body may be 0.64 mm. The gasket according to the first embodiment may be designed so that the angle between the inner and outer surfaces of the body may be 1 (one) degree and the second thickness d2 of the other end of the body may be 0.69 mm. The gasket according to the second embodiment may be designed so that the angle between the inner and outer surfaces of the body may be 2 (two) degrees and the second thickness d2 of the other end of the body may be 0.74 mm. The size of the gap between the gasket and the crimping part may be measured as a maximum width of the gap based on the cross-section of a secondary battery.

TABLE 1

| | Comparative | First | Second |
|---|---|---|---|
| Category | Example | Embodiment | Embodiment |
| Gap Size | 0.08 mm | 0.04 mm | 0.01 mm |

Referring to Table 1, when an angle between the inner surface and the outer surface of the body is approximately 2 (two) degrees, the size of the gap between the gasket and the crimping part may be reduced.

Table 2 below illustrates an experiment measures whether a whitening phenomenon occurs with respect to the secondary battery to which the gasket according to the first embodiment and the gasket according to the comparative example are applied. After the secondary battery according to the comparative example and the secondary battery according to the first embodiment are placed in an environment of 60° C. and 90% relative humidity, it may be determined whether contaminants due to the whitening phenomenon are detected on the upper surface of the secondary battery (e.g., the upper surface of the cap assembly) through Scanning Electron Microscopy (SEM analysis) and Energy Dispersive Spectroscopy (EDS analysis).

TABLE 2

| Category | Comparative Embodiment | First Embodiment |
|---|---|---|
| Gap Size | 0.08 mm or more | 0.04 mm or less |
| SEM/EDS | F(Electrolyte), Al Detection | Al Detection |
| Analysis | | |
| Contamination | 28.6% (26F/91) | 0% (0F/95) |
| Level | | |

According to Table 2, no contaminants due to the whitening phenomenon are detected when the angle between the inner and outer surfaces of the body is approximately 2 (two) degrees and the size of the gap between the gasket and the crimping part is 0.04 mm or less.

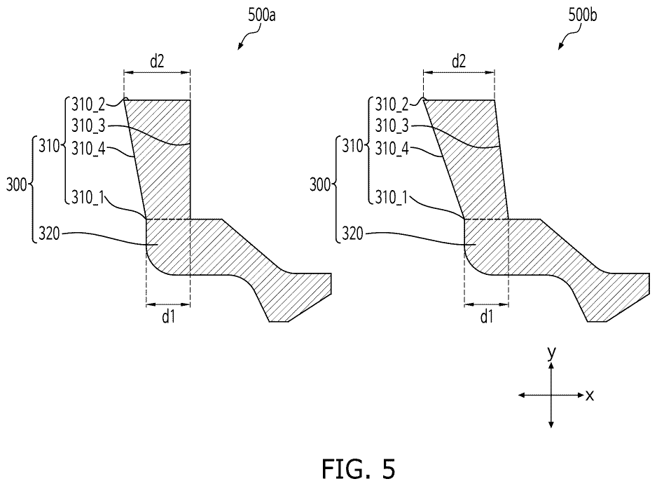

FIG. 5 is a cross-sectional view illustrating the gasket 300 for a secondary battery according to some embodiments of the present disclosure. Particularly, FIG. 5 is an enlarged cross-sectional view illustrating part of the gasket (e.g., 300 of FIG. 3). A redundant description of some aspects of FIG. 4 will be omitted in a description of FIG. 5.

Referring to a first example 500a, the outer surface 310_4 of the body 310 may be inclined toward an outer side of the gasket 300 to have a predetermined angle with respect to the central axis (Y-axis) of the gasket 300, and the inner surface 310_3 of the body 310 may be parallel to the central axis (Y-axis) of the gasket 300. Accordingly, the thickness d1 of one end 310_1 of the body 310 may be smaller than the second thickness d2 of the other end 310_2 of the body 310.

Referring to a second example 500b, the outer surface 310_4 of the body 310 may be inclined toward the outer side of the gasket 300 to have a first angle with respect to the central axis (Y-axis) of the gasket 300, and the inner surface 310_3 may be inclined toward the outer side of the gasket 300 to have a second angle with respect to the central axis (Y-axis) of the gasket 300. The first angle between the outer surface 310_4 of the body 310 and the central axis (Y-axis) of the gasket 300 may be different from the second angle between the inner surface 310_3 of the body 310 and the central axis (Y-axis) of the gasket 300. In some embodiments, the first angle may be greater than the second angle. Accordingly, the first thickness d1 may be smaller than the second thickness d2.

The angle between the inner surface 310_3 and the outer surface 310_4 of the body 310 may be from about 1 (one) degrees to about 3 (three) degrees. The outer surface 310_4 of the body 310 may be formed with an inclination from about 1 (one) degree to about 3 (three) degrees toward the outer side of the gasket 300 than the inner surface 310_3 of the body 310.

The inner surface 310_1 and/or the outer surface 310_4 of the body 310 may be inclined toward the outer side of the gasket 300, so that the inner surface 310_3 of the body 310 may not interfere with the cap assembly. Accordingly, the cap assembly may be easily inserted into the inside of the gasket 300. In addition, the inner surface 310_3 of the body 310 may be inclined toward the outer side of the gasket 300, so that easier demolding during the injection molding process of the gasket 300 may enhance the efficiency of the manufacturing process.

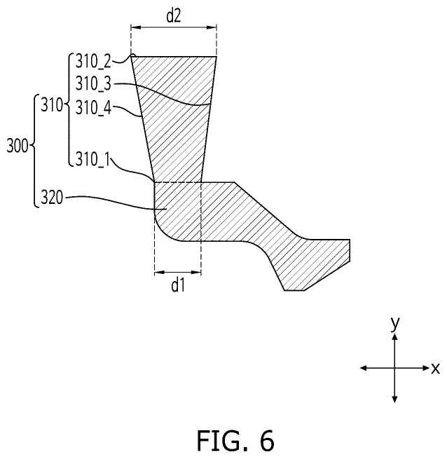

FIG. 6 is a cross-sectional view illustrating the gasket 300 for a secondary battery according to some embodiments of the present disclosure. Particularly, FIG. 6 is an enlarged cross-sectional view illustrating part of a gasket (e.g., 300 of FIG. 3). A redundant description of some aspects of FIG. 4 and FIG. 5 will be omitted from a description of FIG. 6.

As shown in FIG. 6, the outer surface 310_4 of the body 310 may be inclined toward the outer side of the gasket 300 to have a first angle with respect to the central axis (Y-axis) of the gasket 300, and the inner surface 310_3 may be inclined toward the inside of the gasket 300 to have a second angle with respect to the central axis (Y-axis) of the gasket 300. Accordingly, the first thickness d1 may be smaller than the second thickness d2.

The angle between the inner surface 310_3 and the outer surface 310_4 of the body 310 may be from about 1 (one) degree to about 3 degrees. The sum of the first angle, between the outer surface 310_4 of the body 310 and the central axis (Y-axis) of the gasket 300, and the second angle, between the inner surface 310_3 of the body 310 and the central axis (Y-axis) of the gasket 300, may be in a range from about 1 (one) degree to about 3 (three) degrees.

The inner surface 310_3 of the body 310 may be inclined toward the inside of the gasket 300, and the outer surface 310_4 of the body 310 may be inclined toward the outer side of the gasket 300 so that the gasket 300 may not interfere with the cap assembly and the case.

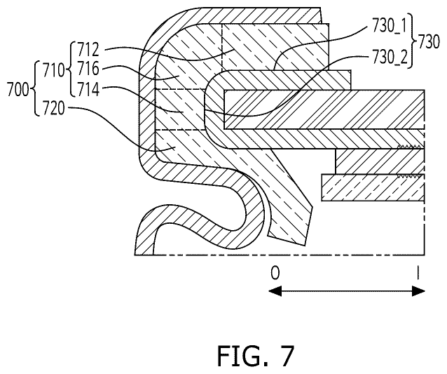

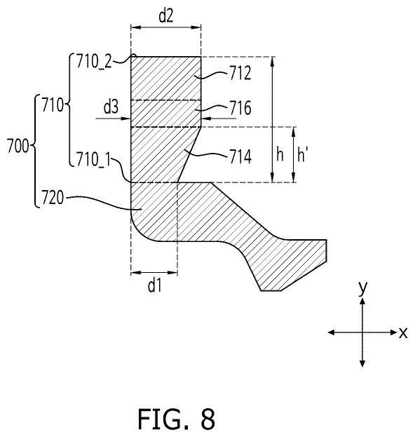

FIG. 7 illustrates a gasket 700 for a secondary battery according to some embodiments of the present disclosure. FIG. 8 is a cross-sectional view illustrating a gasket for a secondary battery according to some embodiments of the present disclosure.

FIG. 7, particularly, is an enlarged cross-sectional view of the gasket 700 assembled inside the secondary battery. The gasket 700 may include a body 710 and an extension 720 that extends downward from a lowermost end of the body 710.

The gasket 700 may be arranged to surround a cap assembly 730. The body 710 may include a horizontal part 712 contacting an upper surface 730_1 of the cap assembly 730, a vertical part 714 contacting a side surface 730_2 of the cap assembly 730, and a bending part 716 that connects the horizontal part 712 to the vertical part 714. The horizontal part 712, the vertical part 714, and the bending part 716 may be integrally formed, and the gasket 700 may be bent in the inward direction I with the crimping part to surround the cap assembly 730.

FIG. 8, particularly, is an enlarged cross-sectional view illustrating part of the gasket 700 shown in FIG. 7. The thickness of the body 710 may vary depending on the height of the body 710. The thickness of the body 710 may be the first thickness d1 at one end 710_1 of the body 710 contacting the extension 720, and the thickness of the body 710 may be the second thickness d2 at the other end 710_2 of the body 710. The first thickness d1 may be smaller than the second thickness d2. With respect to at least some sections of the body 710, the thickness of the body 710 may increase from the one end 710_1 of the body 710 toward the other end 710_2 of the body 710. In some embodiments, the thickness of the body 710 with respect to some sections of the body 710 may increase from the one end 710_1 of the body 710 toward the other end of the body 710, and the thickness of the remaining sections of the body 710 may be uniform.

A third thickness d3 of the body 710 corresponding to the bending part 716 may be greater than the thickness of the one end 710_1 of the body 710. The bending part 716 may be bent when the body 710 is closely attached to the cap assembly. The bending part 716 may be positioned at a specific height h′ that is from about 20% to about 30% of a height h of the body 710 (e.g., a height from the one end 710_1 of the body 710 to the other end 710_2 of the body 710). However, a height h′ is not limited thereto. A height h′ may vary within a predetermined range depending on the design of the gasket and/or the secondary battery.

The thickness of the body 710 may increase toward the bending part 716 in a section from the one end 710_1 of the body 710 to the bending part 716 (referred to as a ‘specific section’). With respect to the specific section, the inner surface and/or the outer surface of the body 710 may be inclined at a predetermined angle with respect to the central axis (Y-axis) of the gasket 700.

According to some embodiments, an angle between the inner surface and the outer surface of the body 710 for the specific section may be from about 1 (one) degree to about 3 (three) degrees. When the first thickness d1 of one end 710_1 of the body 710 is about 0.64 mm and the height of the body 710 is about 3.0 mm, the third thickness d3 of the bending part 716 may be from about 0.65 mm to about 0.7 mm, which may be from about 0.01 mm to about 0.05 mm greater than the first thickness d1. In addition, the third thickness d3 may be from about 101% to about 110% of the first thickness d1. However, the ranges of the first thickness d1 and the third thickness d3 are not limited thereto and may flexibly vary within a predetermined range depending on the design.

Because the third thickness d3 of the bending part 716 of the gasket 700 is formed greater than the thickness d1 of one end 710_1 of the body 710, the bending part 716 may be closely attached to a case and/or a cap assembly without a gap.

FIG. 8 illustrates that the thickness of the body 710 increases in a specific section from the one end 710_1 of the body 710 to a specific height h′, and the thickness of the body 710 remains constant in sections other than the specific section, but the present disclosure is not limited thereto. A thickness of the body 710 may increase from one end 710_1 of the body 710 toward the other end 710_2 of the body 710 in a plurality of sections of the body 710, and, further, a thickness of the body 710 may be uniform in sections other than the plurality of sections. In some embodiments, the thickness of the body 710 may increase both in the specific section and in sections other than the specific section, but a rate of the thickness increase may be different in the specific section compared to sections other than the specific section. Within the range where the thickness d3 of the bending part 716 is greater than the one end 710_1 of the body 710 at a predetermined ratio, the shape of the gasket 700 may vary depending on the design of the gasket and/or the secondary battery.

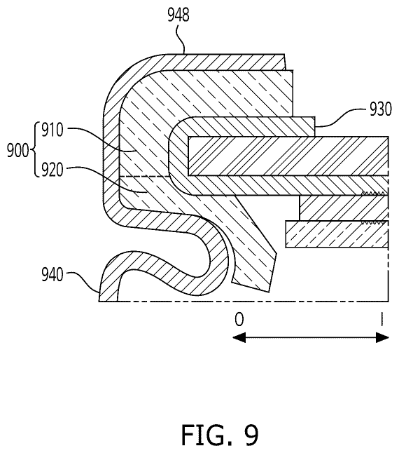

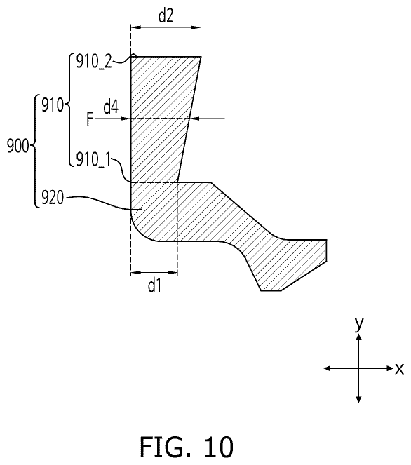

FIG. 9 is a view of a gasket 900 for a secondary battery according to some embodiments of the present disclosure. FIG. 10 is a cross-sectional view illustrating a gasket 900 for a secondary battery according to some embodiments of the present disclosure. A redundant description of aspects of FIG. 7 and FIG. 8 will be omitted in descriptions of FIG. 9 and FIG. 10.

FIG. 9, particularly, is an enlarged cross-sectional view of the gasket 900 assembled in the secondary battery. The gasket 900 may include a body 910 and an extension 920 that extends from one end of the body 910.

According to some embodiments of the present disclosure, the side wall of a case 940 may include a crimping part 948. The crimping part 948 may be bent in the inward direction I and may press and fix the cap assembly 930 and the gasket 900. As the crimping part 948 is bent, the body 910 may be bent at a specific position F to surround the cap assembly 930.

FIG. 10, particularly, is an enlarged cross-sectional view illustrating part of the gasket 900 shown in FIG. 9. According to some embodiments, the thickness of the body 910 at one end 910_1 of the body 910 may be a first thickness d1, and the thickness of the body 910 at the other end 910_2 of the body 910 may be a second thickness d2. The first thickness d1 may be smaller than the second thickness d2. With respect to at least some sections of the body 910, the thickness of the body 910 may increase from the one end 910_1 of the body 910 toward the other end 910_2 of the body 910.

A fourth thickness d4 of the body 910 at a specific position F where the gasket 900 is bent by a crimping part may be greater than the thickness of the one end 910_1 of the body 910. The thickness of the body 910 may increase from the one end 910_1 of the body 910 to the specific position F. With respect to the section from the one end 910_1 of the body 910 to the specific position F, the inner surface and/or outer surface of the body 910 may be inclined at a predetermined angle with respect to the central axis (Y-axis) of the gasket 900.

According to some embodiments, the angle between the inner surface and the outer surface of the body 910 for the section from the one end 910_1 of the body 910 to the specific location F may be in the range from about 1 (one) degree to about 3 (three) degrees. When the first thickness d1 of the one end 910_1 of the body 910 is about 0.64 mm and a height of the body 910 is about 3.0 mm, the fourth thickness d4 at the specific location F may be from about 0.65 mm to about 0.7 mm, which may be from about 0.01 mm to about 0.05 mm greater than the first thickness d1. In addition, the fourth thickness d4 may be from about 101% to about 110% of the first thickness d1. However, the ranges of the first thickness d1 and the fourth thickness d4 are not limited thereto and may vary within a predetermined range depending on a design of the gasket or the secondary battery.

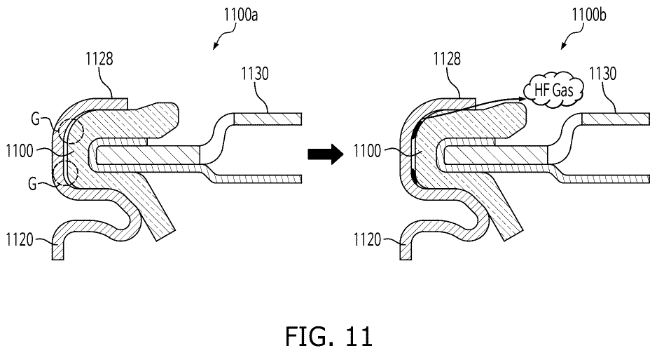

FIG. 11 is an illustration comparing two gaskets for a secondary battery according some embodiments of the present disclosure.

A first example 1100a and a second example 1100b are enlarged cross-sectional views illustrating a gasket 1100 for a secondary battery according to a comparative example is assembled in a secondary battery. A side wall of a case 1120 may be bent in an inward direction with respect to the radial direction of the case 1120 to press and fix a cap assembly 1130 and the gasket 1100. As the crimping part 1128 is bent, the gasket 1100 may be bent to surround the cap assembly 1130 along with the crimping part 1128.

Referring to the first example 1100a, when the crimping part 1128 and the gasket 1100 are not completely sealed, so that a gap G is formed between the crimping part 1128 and the gasket 1100 and/or between the cap assembly 1130 and the gasket 1100, an electrolyte may flow in through the gap G. The electrolyte flowing in through the gap G may react with water vapor (or water) in the air, thereby generating hydrofluoric acid (HF) gas, as in the second example 1100b. The hydrofluoric acid gas may react with materials such as aluminum (Al) and nickel (Ni) that constitute the case 1120 or the cap assembly 1130, thereby causing a whitening phenomenon on the secondary battery.

In the case of the gasket according to the present disclosure, as the gasket is closely attached to the crimping part 1128, the gap G between the gasket and the crimping part 1128 may be minimized. Accordingly, an inflow of an electrolyte through the gap G between the gasket and the crimping part 1128 and an occurrence of hydrogen fluoride gas leakage may be suppressed, thereby preventing damage to the materials of the case 1120 and the cap assembly 1130.

Although the present disclosure has been described above with respect to some embodiments thereof, the present disclosure is not limited thereto. Various modifications and variations can be made thereto by those skilled in the art within the spirit of the present disclosure.

What is claimed is:

1. A secondary battery comprising:
an electrode assembly;
a case having a cylindrical shape that comprises a bottom, a side wall connected to the bottom, and an opening opposite to the bottom, the case being configured to accommodate the electrode assembly;
a cap assembly placed over the opening of the case; and
a gasket disposed between the cap assembly and the case,
wherein the gasket comprises a body and an extension that extends in an inward direction of the case from one end of the body toward another end of the body, and
wherein a first thickness d1 of the one end of the body is smaller than a second thickness d2 of the another end of the body.

2. The secondary battery as claimed in claim 1, wherein an angle between an outer surface of the body and an inner surface of the body is in a range from about 1 degree to about 3 degrees.

3. The secondary battery as claimed in claim 1, wherein a thickness of the body increases from the one end of the body toward the another end of the body.

4. The secondary battery as claimed in claim 3, wherein a diameter r1 of an inner surface of the body decreases from the one end of the body toward the another end of the body.

5. The secondary battery as claimed in claim 4, wherein the diameter r1 of the inner surface of the body is smaller than or the same as a diameter of an outer surface of the cap assembly.

6. The secondary battery as claimed in claim 3, wherein a diameter r2 of an outer surface of the body increases from the one end of the body toward the another end of the body.

7. The secondary battery as claimed in claim 6, wherein the diameter r2 of the outer surface of the body is smaller than or the same as a diameter of an inner surface of the side wall.

8. The secondary battery as claimed in claim 3, wherein a diameter r1 of an inner surface of the body decreases from the one end of the body toward the another end of the body, and
wherein a diameter r2 of an outer surface of the body increases from the one end of the body toward the another end of the body.

9. The secondary battery as claimed in claim 1, wherein the second thickness d2 is from about 105% to about 115% of the first thickness d1.

10. The secondary battery as claimed in claim 1, wherein the second thickness d2 is greater than the first thickness d1 by a length of from about 0.05 mm to about 0.15 mm.

11. The secondary battery as claimed in claim 1, wherein the body comprises:
a horizontal part configured to contact an upper surface of the cap assembly;
a vertical part configured to contact a side surface of the cap assembly; and
a bending part configured to connect the horizontal part of the body to the vertical part of the body,
wherein a third thickness d3 of the body at the bending part of the body is greater than the first thickness d1.

12. The secondary battery as claimed in claim 11, wherein the third thickness d3 is from about 101% to about 110% of the first thickness d1.

13. The secondary battery as claimed in claim 11, wherein the third thickness d3 is greater than the first thickness d1 by a length of from about 0.01 mm to about 0.05 mm.

14. The secondary battery as claimed in claim 1, wherein the side wall comprises, a crimping part bent in the inward direction of the case to press and fix the cap assembly and the gasket,
wherein the body is bent at a specific position F and surrounds the cap assembly.

15. The secondary battery as claimed in claim 14, wherein a fourth thickness d4 of the body at the specific position F of the body is from about 101% to about 110% of the first thickness d1.

16. A gasket for a secondary battery comprising:
a body having a cylindrical shape; and
an extension that extends in an inward direction of the body from one end of the body to another end of the body,
wherein a first thickness d1 of the one end of the body is smaller than a second thickness d2 of the another end of the body.

17. The gasket for the secondary battery as claimed in claim 16, wherein an angle between an outer surface of the body and an inner surface of the body is in a range from about 1 degree to about 3 degrees.

18. The gasket for the secondary battery as claimed in claim 16, wherein a thickness of the body increases from the one end of the body toward the another end of the body, and
wherein a diameter r1 of an inner surface of the body decreases from the one end of the body toward the another end of the body.

19. The gasket for the secondary battery as claimed in claim 16, wherein a thickness of the body increases from the one end of the body toward the another end of the body, and
wherein a diameter r2 of an outer surface of the body increases from the one end of the body toward the another end of the body.

20. The gasket for the secondary battery as claimed in claim 16, wherein the second thickness d2 is from about 105% to about 115% of the first thickness d1.
